(19) United States
(12) Patent Application Publication
(10) Pub. No.: US 2016/0035145 A1
(43) Pub. Date: Feb. 4, 2016

(54) Method and Apparatus for Vehicle Data Gathering and Analysis

(71) Applicant: Ford Global Technologies, LLC, Dearborn, MI (US)

(72) Inventors: Douglas James McEwan, Royal Oak, MI (US); Christopher Paul Glugla, Macomb, MI (US); Michael Damian Czekala, Canton, MI (US); Garlan J. Huberts, Milford, MI (US)

(21) Appl. No.: 14/448,204

(22) Filed: Jul. 31, 2014

(51) Int. Cl. G07C 5/00

(52) U.S. Cl. CPC G07C 5/006; G07C 5/008

(57) ABSTRACT

A system includes a processor configured to receive vehicle data from a plurality of vehicles. The processor is also configured to save the data with respect to a reporting vehicle. Further, the processor is configured to associate the data with any recent reporting vehicle repairs. The processor is additionally configured to analyze the associated data with respect to other vehicles having similar repairs to determine root causes of malfunction leading to the repair and save a record of identified causes of the malfunction.

### TECHNICAL FIELD

The illustrative embodiments generally relate to a method and apparatus for vehicle data gathering and analysis.

### BACKGROUND

When a customer brings a vehicle into a dealership for maintenance, it is often difficult to communicate all the relevant information relating to a possible issue. The customer may forget to mention certain information, and, in other cases, the customer may not even pay attention to relevant information.

U.S. Application 2012/0296514 generally relates to a method of conducting vehicle usage data analysis is provided. The method includes providing usage data about at least one vehicle to a database. The usage data may be analyzed and compared to a member of a set of vehicle development models to determine whether to update a vehicle development model. The usage data may also be analyzed to determine whether to transmit a communication to a vehicle.

### SUMMARY

In a first illustrative embodiment, a system includes a processor configured to receive vehicle data from a plurality of vehicles. The processor is also configured to save the data with respect to a reporting vehicle. Further, the processor is configured to associate the data with any recent reporting vehicle repairs. The processor is additionally configured to analyze the associated data with respect to other vehicles having similar repairs to determine root causes of malfunction leading to the repair and save a record of identified causes of the malfunction.

In a second illustrative embodiment, a system includes a processor configured to receive vehicle data from a plurality of vehicles. The processor is further configured to save the data with respect to a reporting vehicle. The processor is additionally configured to analyze the data in comparison to data identifying causes of problems not yet experienced by the reporting vehicle and report to the driver of the vehicle any likely upcoming problems, identified by a correlation of the saved data with the data identifying causes of problems.

In a third illustrative embodiment, a method includes receiving vehicle data from a plurality of vehicles. The method also includes saving the data with respect to a reporting vehicle. The method further includes analyzing the data in comparison to data identifying causes of problems not yet experienced by the reporting vehicle and reporting to the driver of the vehicle any likely upcoming problems, identified by a correlation of the saved data with the data identifying causes of problems.

### BRIEF DESCRIPTION OF THE DRAWINGS

FIG. 1 shows an illustrative vehicle computing system;

FIG. 2 shows an illustrative process for data gathering;

FIG. 3 shows an illustrative process for data correlation;

FIG. 4 shows an illustrative process for data analysis; and

FIG. 5 shows an illustrative process for customer notification.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

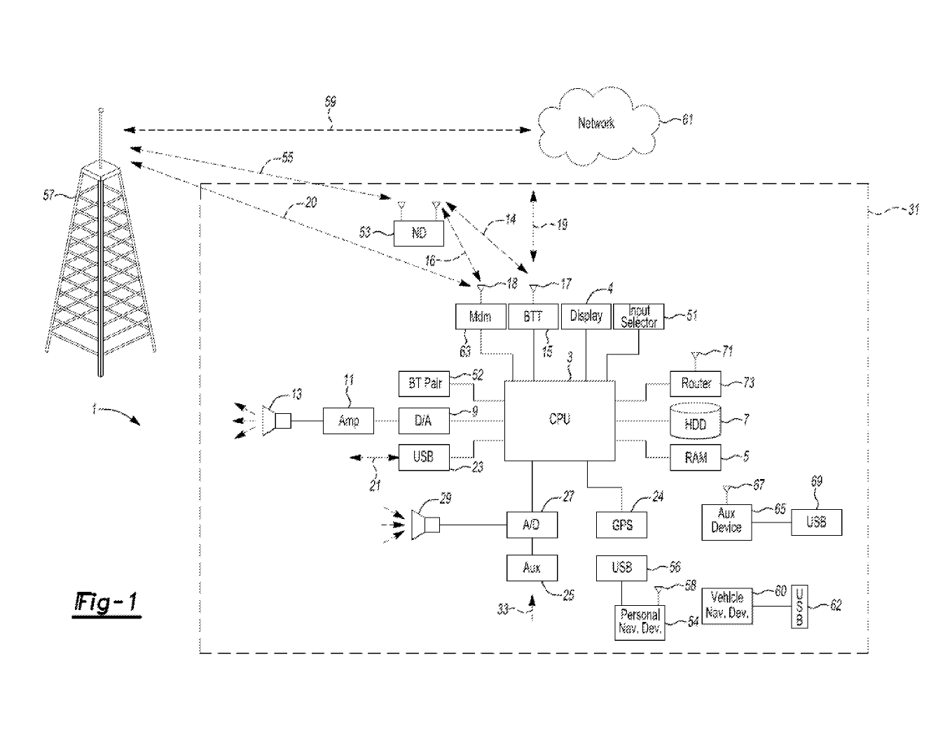

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

In solving any vehicle issue, it helps to have access to all the relevant information related to the issue. When a vehicle is serviced at a dealer, a service technician asks a series of questions and tries to gather the relevant information from the customer. The technician can ask general questions including, for example, what kind of noise was heard, what was the weather like, what was the road like, was it stop and go traffic, etc. The customer, however, may not have made note of all these details.

Further, the technician may not even ask for the appropriate information, because the root cause of a new issue may not fully be known. In the illustrative embodiments, massive amounts of data are gathered from numerous vehicles. This data can be analyzed in conjunction with repairs and warranty claims to quickly identify the causes of problems. Further, this data can be used to help identify possible problems in advance.

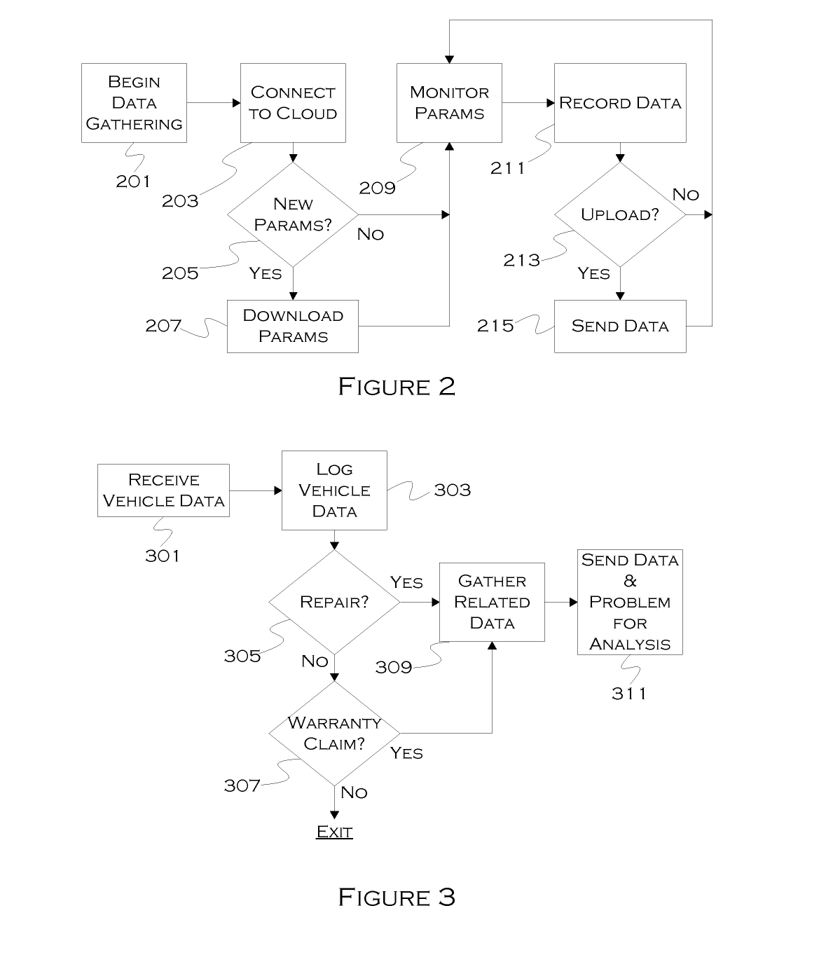

FIG. 2 shows an illustrative process for data gathering. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative embodiment, the process runs on a vehicle system that can gather vehicle data and report the data to a remote server, such as an OEM server. In this example, the process begins data gathering 201. Since different data may be needed at different times, or new data may be identified for gathering, the process connects to a remote resource, such as the cloud 203. When the connection is established, the process can check for any new data parameters to be gathered 205.

Since the data gathering is specific to each vehicle, there may be certain data that is desirable for particular makes and models. Using the data gathering process, the system can gather the data from each vehicle as appropriately specified by the OEM system. Any relevant data parameters can be downloaded 207.

Once all parameters (existing and new) have been established, the process can monitor the appropriate vehicle systems 209. As the systems are monitored, the relevant data can be recorded 211. This data can reside on the vehicle system until transfer to an OEM server is appropriate. The data can include, but is not limited to, vehicle speeds, fuel data, weather data, traffic data (recognizable, for example, by stop and go movement), acceleration/deceleration data and any other relevant data that may be useful in identifying vehicle problems.

Once the data is ready for upload, which may be periodically or continuous as the data is gathered 213, the process can package and send the relevant data for remote storage and analysis. Using this data, gathered from any number of vehicles on the road, an OEM can pinpoint the likely causes of various vehicle issues, and alert drivers whose vehicles demonstrate similar patterns of a possible upcoming issue that might arise. Early maintenance of these issues can potentially save millions of dollars in repair costs nationwide, annually.

FIG. 3 shows an illustrative process for data correlation. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example shown in this illustration, the back-end process for cataloging data is shown. When a vehicle is ready to report data, communication (typically, although not necessarily, through a wireless device in wireless communication with a vehicle computer) is established with a remote server. The remote server, running the process, receives the vehicle data 301. The vehicle data may then be saved, if desired, to a vehicle specific log 303, as well as used to generally populate a database with make/model reporting data.

The process then checks to see if the specific vehicle has had any repair 305 or warranty work 307 done. Checking this will show if there were any issues that were corrected on a vehicle. If the vehicle has had any maintenance or repair work, the process can gather the relevant data to the repair, including, for example, but not limited to, date of repair, type of repair, malfunctioning systems/parts, etc 309. This data, along with vehicle log data providing all the various gathered vehicle data, can then be sent to another process for analysis, so that likely causes of a particular repair may be determined 311.

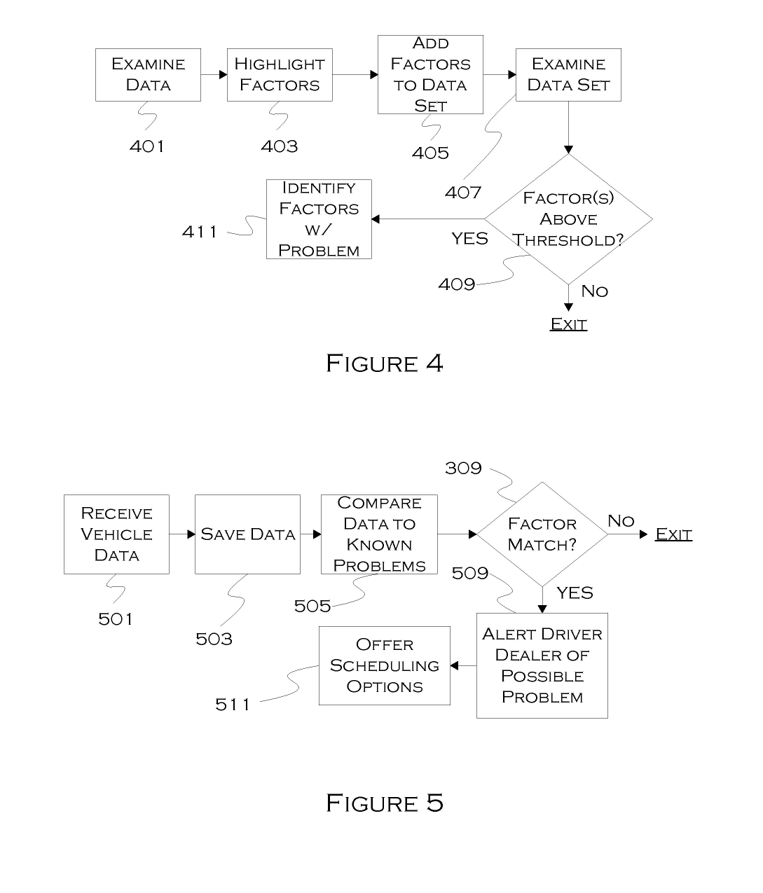

FIG. 4 shows an illustrative process for data analysis. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, vehicle part malfunction and warranty work is examined in conjunction with gathered data in an attempt to determine the cause of a problem. For example, unusual wear on an engine belt on a single vehicle may be associated with a variety of factors. Some guesswork can be made as to what is a likely cause, but a single incidence leaves a lot of room for misinterpretation. On the other hand, if five thousand vehicles demonstrate a problem, and each is run in areas where the temperature is over 90 degrees, and the humidity is low, as well as commonly in stop and go traffic, then it may be determined that these are root causes of a possible problem. Future designs can address this problem, and, at the same time, customers in such areas or driving conditions may be notified to keep a close eye on the belt condition.

In this example, data related to each repair/maintenance issue is reported and examined by the process 401. Based on previous observations, certain data elements related to an issue can be highlighted 403. Initially, the process may examine a large data set for each problem, recording values and looking for correlations.

As more and more common data values are determined for each problem, the analyzed data set can be reduced to focus in on the issue. Highlighted factors can represent data identified for analysis related to the problem. The data from each factor, for each vehicle, can be added to the common data set 405. The data set can then be examined 407 to narrow down the values in each factor that may relate to a problem. For example, in the belt issue above, it may be noticed that vehicles operating in environments with 90 degree Fahrenheit temperature have the hose issue. Further analysis may reveal that the issue is most common when the operating temperatures are above 93 degrees over 70% of the time. Through crowdsourced data, the causes of problems can be narrowed and narrowed, until causing factors are very specifically pin pointed.

As the factors are examined, when certain factors are above observed thresholds (such as 90 degrees, in the above example) 409, the process can associate the factor as a possible cause of the problem 411. The thresholds can be adjusted dynamically as more data is gathered, typically starting at outlying values and working towards a specific problem causing value.

FIG. 5 shows an illustrative process for customer notification. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the process can serve to identify upcoming possible problems in a driver's vehicle before the problem ever occurs. This can serve to incentivize drivers to participate in the data gathering, if driver permission is desired for participation.

When the vehicle data from a given vehicle is received 501, the process can save the data with respect to a vehicle record 503. For each time the data is recovered, historical data from the data set can be examined and compared to known problems 505. For example, if the exemplary belt problem is most common in vehicles operating 70% of the time in temperatures exceeding 93 degrees Fahrenheit, the process can check to see how often the vehicle is operated in these conditions. It may be that the conditions are not met initially, but, for example, if the owner moves to a warmer climate, the data may eventually match.

If there is a match in the data, compared to any problem 507, the process can alert the driver and/or a preferred dealer of a possible problem. If, for example, a new belt or, in other cases, a fix is available, the driver may be advised to take advantage of the fix before a larger problem develops. For example, it may be the case that in some instances, environment and driving condition can wear engine parts, but maybe a protective coating can be provided in certain environments that will come at a much lower cost than the cost of eventual maintenance if the coating is not obtained.

The processor can also communicate with the vehicle to offer to contact a dealer. Using database resources, the processor can identify preferred and local dealers 509. If the user selects, or has specified, a preferred dealer, the processor can communicate the relevant information to the dealer, so that when the user takes the vehicle in, the dealer already expects the vehicle and may have already identified likely problems.

Through the use of crowd sourced data, problems and their causes can be quickly identified and driver experiences can be improved by preventing expensive problems before they occur.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive vehicle data from a plurality of vehicles;
save the data with respect to a reporting vehicle;
associate the data with any recent reporting vehicle repairs;
analyze the associated data with respect to other vehicles having similar repairs to determine root causes of malfunction leading to the repair; and
save a record of identified causes of the malfunction.

2. The system of claim 1, wherein the data includes vehicle system data.

3. The system of claim 1, wherein the data includes environmental data.

4. The system of claim 1, wherein the data includes driving condition data.

5. The system of claim 1, wherein the analyzing includes comparing a data element to an identified threshold level likely to cause the malfunction.

6. The system of claim 1, wherein the data is further saved to a vehicle database in a record associated with a make and model of the reporting vehicle.

7. A system comprising:
a processor configured to:
receive vehicle data from a plurality of vehicles;
save the data with respect to a reporting vehicle;
analyze the data in comparison to data identifying causes of problems not yet experienced by the reporting vehicle; and
report to a driver of the vehicle any likely upcoming problems, identified by a correlation of the saved data with the data identifying causes of problems.

8. The system of claim 7, wherein the data includes vehicle system data.

9. The system of claim 7, wherein the data includes environmental data.

10. The system of claim 7, wherein the data includes driving condition data.

11. The system of claim 7, wherein the analyzing includes comparing a data element to an identified threshold level at which vehicle part malfunction is likely to occur.

12. The system of claim 7, wherein the processor is further configured to offer to communicate with a dealer to address identified likely upcoming problems.

13. The system of claim 12, wherein the processor is further configured to transfer vehicle data to a selected dealer.

14. A method comprising:
receiving vehicle data from a plurality of vehicles;
saving the data with respect to a reporting vehicle;
analyzing the data in comparison to data identifying causes of problems not yet experienced by the reporting vehicle; and
reporting to a driver of the vehicle any likely upcoming problems, identified by a correlation of the saved data with the data identifying causes of problems.

15. The method of claim 14, wherein the data includes vehicle system data.

16. The method of claim 14, wherein the data includes environmental data.

17. The method of claim 14, wherein the data includes driving condition data.

18. The method of claim 14, wherein the analyzing includes comparing a data element to an identified threshold level at which part malfunction is likely to occur.

19. The method of claim 14, further including offering to communicate with a dealer to address identified likely upcoming problems.

20. The method of claim 19, further including transferring vehicle data to a selected dealer.
